(19) United States
(12) Patent Application Publication
(10) Pub. No.: US 2017/0052968 A1
(43) Pub. Date: Feb. 23, 2017

(54) ANALYZING AND VIEWING SOCIAL INTERACTIONS BASED ON PERSONAL ELECTRONIC DEVICES

(71) Applicant: DigitalGlobe, Inc., Longmont, CO (US)

(72) Inventor: James Stokes, Richmond, VA (US)

(21) Appl. No.: 15/239,729

(22) Filed: Aug. 17, 2016

Related U.S. Application Data
(60) Provisional application No. 62/206,262, filed on Aug. 17, 2015.

(51) Int. Cl. G06F 17/30

(52) U.S. Cl. CPC G06F 17/3087; G06F 17/30867; G06F 17/30554

(57) ABSTRACT

A system for analysis and viewing of social interactions based on user devices, comprising an analysis and geolocation platform stored and operating on a network-connected computing device, that receives social interaction information and analyzes the information, and a visualization engine stored and operating on a network-connected computing device that forms visual representations of the social interaction information, and a method for analysis and viewing of social interactions based on user devices.

### CROSS-REFERENCE TO RELATED APPLICATIONS

This application claims the benefit of, and priority to, U.S. provisional patent application Ser. No. 62/206,262, titled “ANALYZING AND VIEWING SOCIAL INTERACTIONS BASED ON PERSONAL ELECTRONIC DEVICES” and filed on Aug. 17, 2015, the entire specification of which is incorporated herein by reference in its entirety.

### BACKGROUND OF THE INVENTION

Field of the Invention

The disclosure relates to the field of social media, and more particularly to the field of aggregating geospatial, temporal and social media information and the visualization of such aggregated data.

Discussion of the State of the Art

Image analysis has been an important field of technology at least since the period of World War 2, when extensive use of image analysis, photogrammetry, and related technologies was used in conjunction with aerial photography for intelligence and bombing damage assessment purposes (among others). However, the extent of the use of image analysis (particularly image analysis of remotely-sensed images), particularly for identifying or locating targets of interest, has always been limited by the need for highly-trained, specialized image analysts or interpreters. The need for specialized (and expensive) skills has limited the use of image analysis to a correspondingly limited range of applications (notably military, homeland defense, and law enforcement).

The market for image analysis has also historically been limited by the high cost of obtaining images to analyze. In the military arena, the benefits were sufficiently apparent that large numbers of military reconnaissance flights were made over regions of interest since World War 2. But the cost of such flights virtually totally excluded all commercial applications of image analysis. Starting in the 1970s with the Landsat satellite, this began to change as low resolution satellite images became publicly available. A series of new satellites has opened up progressively more applications as the resolution, spectral coverage, geographic coverage, and cost per image have all continuously improved; accordingly, a significant market in commercial remote sensing imagery has emerged. But even this market has been limited from achieving its full potential because of the still-present requirement for expensive, scarce image analysis talent. Some progress has been made in automated image analysis technologies, but for a vast range of current and potential applications, large scale image analysis (such as would be needed when analyzing satellite images of a large region) remains too expensive and too supply-constrained to use.

One common type of image analysis problem is the “search and locate” problem. In this problem, what is needed is to find and to precisely locate one or more targets of interest. For example, in search and rescue, it may be important to find a missing plane using satellite imagery. Another example is the finding and precise location of warships, tanks, or other military targets of interest. Less common but promising applications include such things as assessing hurricane damage by finding and locating damaged buildings and infrastructure, finding and locating potentially important archeological sites (for instance, by identifying possible ruins in deserts), and assessing the scope of a refugee problem by for example counting tents in an area of interest.

In traditional approaches, social media information (such as user comments or uploaded media files such as audio or video recordings or photographs) may be analyzed to find connections or patterns, such as conversations between users across multiple networks through noticeable connections in their posts. However, such approaches are generally inadequate at answering questions of location, such as trying to locate a person of interest, or determine frequented areas or traffic patterns.

Even when location information may be available, for example as a metadata tag attached to an uploaded image (as is common in the art), it is limited in scope and often contributes little to the overall geolocation effort. Furthermore, such information represents only an instantaneous snapshot of location information, “where this user was at this moment”, and does nothing to answer questions of where they were before or since, or any relation to other locations or interactions.

For example, if attempting to locate a person of interest (such as a missing person, wanted criminal or person under investigation, or other such use case), current approaches may allow for locating where they were when a particular posting was made, but they do not enable any form of visualizing their traffic patterns to attempt to deduce where they are likely to be in the future. In tracking groups or populations, momentary snapshots of locations may be visible through the social postings but there is no way to identify migration or movement of or within the group.

Additionally, current implementations do not provide a means for human review of collected data. When aggregating social media content, it is important that it be easy to visualize for a human analyst, such as to observe patterns and form predictions based on the information that may not be possible in a fully-automated (i.e., without human interaction) approach.

What is needed, is a system and method to allow to aggregate and track over time movement, locations and participation in both virtual and real world groups and associations, as well as obtaining a sentiment reading by grouping social media and other communication content into categories and visualizing these in geographical terms.

### SUMMARY OF THE INVENTION

Accordingly, the inventor has conceived, and reduced to practice, in a preferred embodiment of the invention, a platform for crowdsourcing the analysis of images, and particularly for analysis of aerial or satellite images to geolocate one or more targets of interest, or to identify objects or their types.

According to a preferred embodiment of the invention, a system for analyzing and viewing social interactions based on user devices, comprising a geolocation and analytics server comprising at least a plurality of software programming instructions stored in a memory of and operating on a processor of a computing device, configured to receive information from a plurality of social media networks, the information comprising at least social interaction information pertaining to users of the social media network and a plurality of geolocation information; and a visualization engine comprising at least a plurality of software programming instructions stored in a memory of and operating on a processor of a computing device, configured to produce a plurality of visual representations of analyzed social interaction information received from the geolocation and analytics server; wherein the geolocation and analytics server analyzes received social interaction information; wherein the geolocation and analytics server derives new information based at least in part on the results of the analysis; wherein the geolocation and analytics server provides at least a portion of the received and derived social interaction information to the visualization engine; wherein the visualization engine produces a plurality of visual representations based at least in part on the received information; and wherein the visualization engine presents at least a portion of the visual representations to a human user for review, is disclosed.

According to another preferred embodiment of the invention, a method for analyzing and viewing social interactions based on user devices, comprising the steps of receiving, at a geolocation and analytics server comprising at least a plurality of software programming instructions stored in a memory of and operating on a processor of a computing device, configured to receive information from a plurality of social media networks, the information comprising at least social interaction information pertaining to users of the social media network and a plurality of geolocation information, social interaction information; analyzing the information; updating the information with location-based information based at least in part on the analysis results; and storing at least a portion of the information for future reference, is disclosed.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram of an exemplary system architecture for analyzing and viewing social interaction based on personal electronic devices, according to a preferred embodiment of the invention.

FIG. 2 is a system architecture diagram showing a more detailed view of a social interaction geolocation platform, according to a preferred embodiment of the invention.

FIG. 3 is a method flow diagram illustrating an exemplary method for analyzing and geolocating social interactions, according to a preferred embodiment of the invention.

FIG. 4 is a method flow diagram illustrating an exemplary method for visualizing social interactions in a geospatial context.

FIG. 5 shows a use case of the residence finder approach shown later in FIG. 9, according to an exemplary embodiment of the system and method disclosed herein.

FIG. 6 shows an exemplary screen of a visualizing analytic software tool for finding locations of common interest to a group, according to an exemplary embodiment of the system and method disclosed herein.

FIG. 7 shows an exemplary screen of a visualizing analytic software tool, according to an exemplary embodiment of the system and method disclosed herein.

FIG. 8 shows an exemplary screen of a visualizing analytic software tool, identifying residences of individuals or groups on a map, according to an exemplary embodiment of the system and method disclosed herein.

FIG. 9 shows an exemplary screen of a visualizing analytic software tool that relates entities to event series through space and time, according to an exemplary embodiment of the system and method disclosed herein.

FIG. 10 shows an exemplary screen of a visualizing analytic software tool that displays the travel patterns of every one in a data set, according to an exemplary embodiment of the system and method disclosed herein.

FIG. 11 shows an exemplary screen of a visualizing analytic software tool for discovering hidden relationships between individuals, according to an exemplary embodiment of the system and method disclosed herein.

FIG. 12 shows an exemplary screen of the twin finder visualizing analytic software tool, according to an exemplary embodiment of the system and method disclosed herein.

FIG. 13 shows an exemplary screen of an enclave view on a global map, according to an exemplary embodiment of the system and method disclosed herein, enabling identification of countries that a network may affect.

FIG. 14 shows an exemplary screen of real-time geospatial movement of certain people, according to an exemplary embodiment of the system and method disclosed herein, enabling location of entities who actively try not to be seen.

FIG. 15 shows an exemplary screen of a trigger finder that enables the system to track cause and effect through time and space, according to an exemplary embodiment of the system and method disclosed herein.

FIG. 16 shows an exemplary screen of an approach to finding social centers, according to an exemplary embodiment of the system and method disclosed herein.

FIG. 17A shows an exemplary screen according to an exemplary embodiment of the system and method disclosed herein.

FIG. 17B shows an exemplary screen according to an exemplary embodiment of the system and method disclosed herein.

FIG. 17C shows an exemplary screen according to an exemplary embodiment of the system and method disclosed herein.

FIG. 18 is a block diagram illustrating an exemplary hardware architecture of a computing device used in an embodiment of the invention.

FIG. 19 is a block diagram illustrating an exemplary logical architecture for a client device, according to an embodiment of the invention.

FIG. 20 is a block diagram showing an exemplary architectural arrangement of clients, servers, and external services, according to an embodiment of the invention.

FIG. 21 is another block diagram illustrating an exemplary hardware architecture of a computing device used in various embodiments of the invention.

### DETAILED DESCRIPTION

The inventor has conceived, and reduced to practice, in a preferred embodiment of the invention, a platform for crowdsourcing the analysis of images, and particularly for analysis of aerial or satellite images to geolocate one or more targets of interest, or to identify objects or their types.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

The embodiments disclosed herein comprise a visualizing analytics tool that can ingest, present, and analyze intercept data (for example including social media posts, check-ins, and geotags) generated, for example, by the motion of mobile devices, as detected by their GPS devices (may be shared by users, or may be obtained by other means). The system may comprise a local or a cloud-based service (or a combination thereof), with automated ingestion of arbitrarily large numbers of data sources, cloud-based analysis, automated tips to users in threat/opportunity situations, etc.

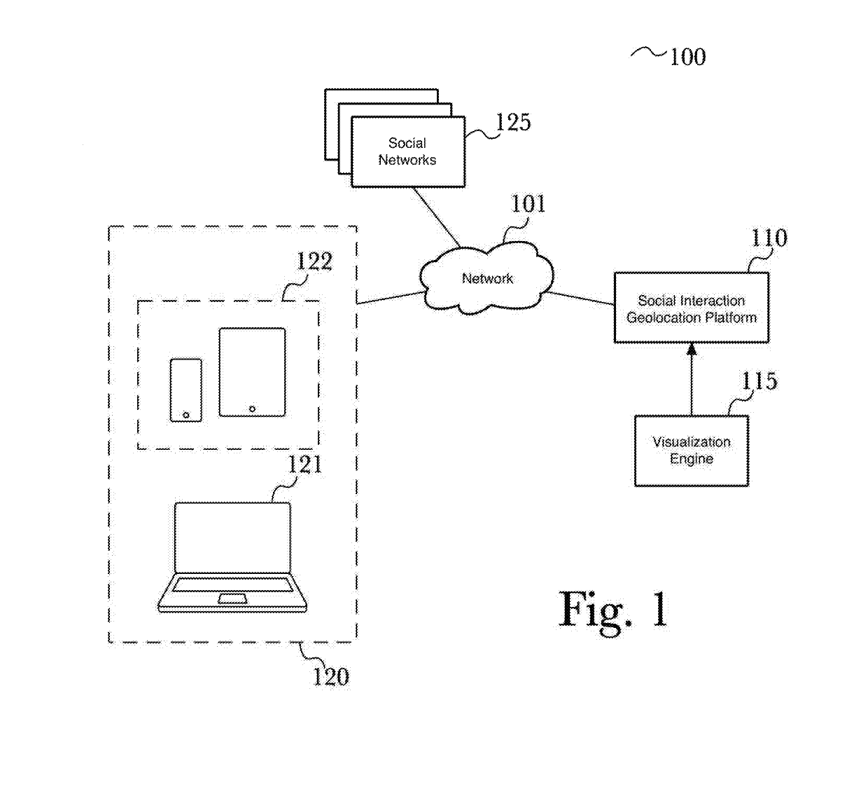

FIG. 1 is a block diagram of an exemplary system architecture 100 for analyzing and viewing social interaction based on personal electronic devices, according to a preferred embodiment of the invention. According to the embodiment, a social interaction geolocation platform 110 may connect via a network 101 such as the Internet or other appropriate data communications network, and may view or interact with social media content postings in a variety of means as illustrated. For example, the platform 110 may traverse social content posting on a plurality of social media networks 125 (such as, for example, FACEBOOK™ or any other social network, several examples of which are given above), performing as a “web crawler” by reading through large numbers of content postings and retrieving any potentially-useful information such as posting metadata (as described below). As further illustrated, the platform may optionally interact directly with user devices 120 such as a personal computing device 121, mobile smartphone 122 or other mobile electronic device. Such interaction may occur in a variety of ways according to the specific device and implementation, such as via a specifically-constructed software application operating on a device (such as a smartphone app) or a software application programming interface (API) that may be utilized by third-party developers to integrate their software applications with the platform (such as, for example, to enable to functionalities offered by the platform from within their existing software applications or web interfaces, for example). In this manner, a variety of information may be collected from both user devices directly, and social media networks where users may be active. As further illustrated, the platform 110 may provide collected or analyzed data to a visualization engine 115, such as to form visual representations of the data or insights gained from analysis of the data by the platform 110.

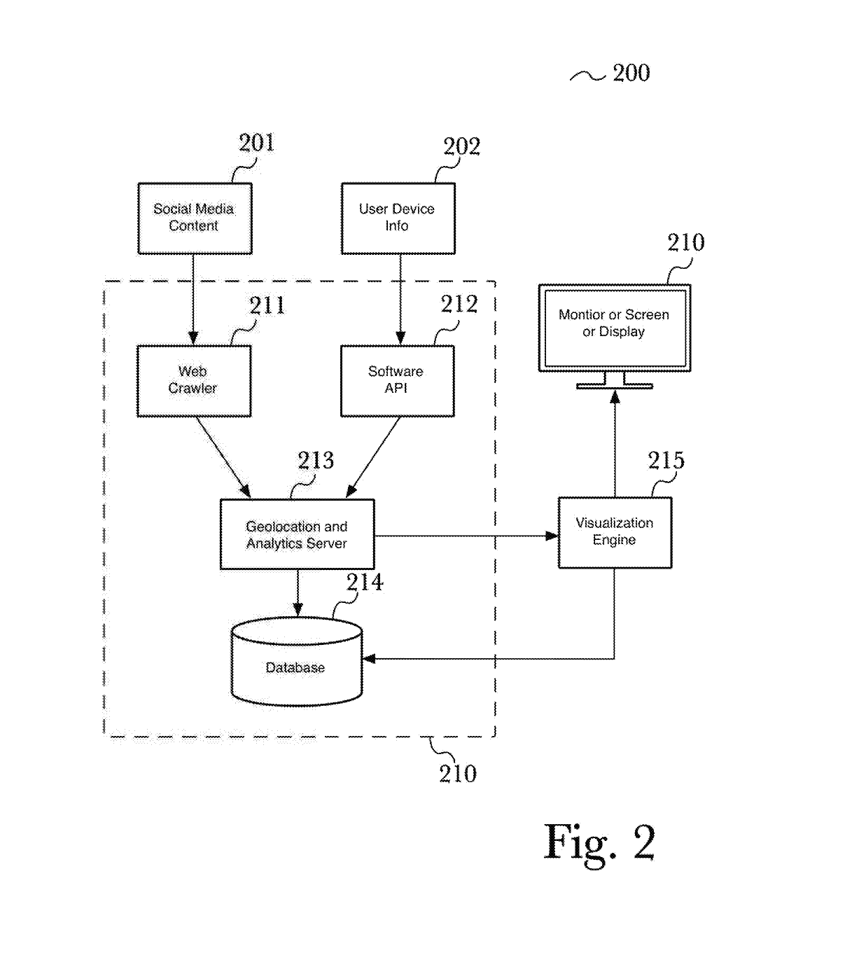

FIG. 2 is a system architecture diagram showing a more detailed view of a social interaction geolocation platform 110, according to a preferred embodiment of the invention. As illustrated, a platform 110 may utilize a web crawler 211 that may be any suitable software application stored and operating on a network-connected computing device such as a server or computer workstation, that may access and interact with (such as in a procedural read-only fashion, known in the art as “crawling”) social media content 201 such as user postings, uploaded audio or video clips, stored files, or other such social interaction information. A platform may also utilize a software application programming interface (API) 212, such as to enable integration with a variety of third-party or external services or products, such as software applications or online services or webpages, such that the platform may be given access to receive or interact with user device information 202, for example location information from a mobile device's internal GPS or other location positioning hardware or software, or hardware identity information, or personal information stored on the device such as owner info or contact information, as are commonly stored and readily accessible on mobile computing devices. In this manner, information may be gained from a plurality of sourced via means suited to the particular information source.

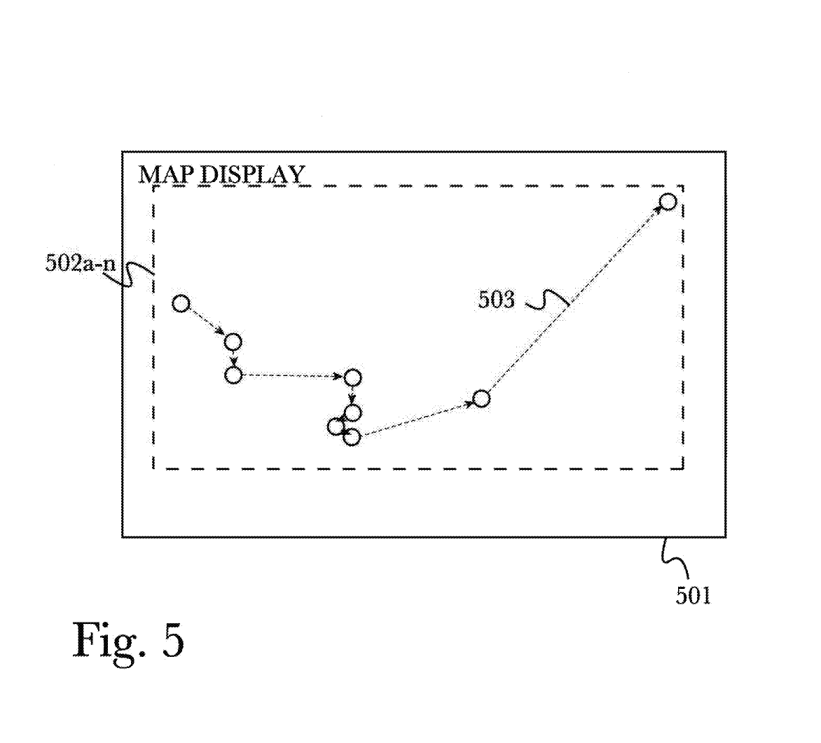

Information from a web crawler 211 and an API 212 may be provided to a geolocation and analytics server 213 that may analyze the received information, such as to identify data of interest (such as user location information), or to form associations between separate pieces of information (such as to associate location information form a user's device with a social network posting they made), such that additional information or insights may be made possible through the processing of received information. Received data and any analytics results may then be stored in a database 214 for future reference, such as for additional analysis or review. Data and analysis results may also be provided to a visualization engine 115, that may be stored and operating on a networked computing device such as a server or computer workstation, and that may be either directly connected to an analytics server 213 (such as operating on the same computing device, or directly connected devices such as within a data center) or may be connected via a network. A visualization engine 115 may then generate visual representations based at least in part on the received data, such as to provide a human-readable visual indicator of insights gained through data collection or analysis. Several examples of such visual representations are described below, referring to FIGS. 5-17. Such visualizations may then be provided to a user via a visual display 210 such as a computer display screen, or they may be stored in a database 214 for future reference (as illustrated, visualizations may be stored in the same database as collected data if desirable, however it should be appreciated that this arrangement is exemplary and any arrangement of data storage may be utilized according to the invention).

When mining social media for geospatial insights, platform 110 may use a great many types and sources of data. In the cases of TWITTER™, for example, usage tracking may give insight into the success of product placements in movies. In another example, a user could place a cell phone at the entrance of a retail establishment to count phones going in and then coming out. From this, platform 110 can derive when, and for how long, shoppers were in the store. The data can also be used to validate Twitter data and parking lot counter data.

By analyzing social media connections between users, or events directed to or from users, the nature of social networks can be identified and characterized. Traditionally this is done by analyzing phone or email events, but the nature of social media offers several ways to analyze relationships. For example, users can “follow” other users. However, when users follow each other (co-follow) the nature of the relationship can be said to be stronger. And, when users tweet directly at each other, or mention each other, their relationship is likely stronger still. Finally, the concept of a retweet implies that a user finds the content of the original message to be important. Heavily retweeted events can be used to identify influential individuals and emerging themes of interest.

Based on these identified relationships, important users who are central to networks or who connect otherwise unconnected networks can also be identified and analyzed to understand influencers, etc. Combining location information with social networks can further an understanding of social networks and the critical individuals in them.

Social media connections can also identify locations of clusters of followers, as well as groups of followers away from the original person(s) of interest. For example, if a pocket of users within Khartoum maintained a high percentage of followers predominantly out of Saudi Arabia, the system could assess the likelihood of a possible Saudi enclave in a given area within Khartoum. These follower enclaves can enable the analyst to make geographic connections from social network information. These social network analyses are becoming well established, but tying the members of the network to specific locations can enhance an understanding of these networks and focus resources at the places that are important to them.

Current tools for mapping user internet data, including social media data, may include Friends in Common, Centrality, Betweenness, Location Critical Users (Forrest Gump), Influential Individuals (Retweet Analysis), and Follower Enclaves. Most of these tools and analyses focus on specific places or a small subset of data and users, and thus can be effectively processed on the desktop. However, the vast and growing numbers of social media participants worldwide creates vast amounts of data every day. Much of that data has geotags and is thus Geospatial Big Data (GBD). To process and analyze these data sources at scale, an analysis platform may need to be cloud-enabled at some level.

By utilizing cloud computing concepts and techniques, many other analyses that were previously difficult or impossible are now feasible, and the analytical products they provide are novel and useful. For example, processing the day/night locations of every user in a large social media dataset can give a sense of the residential and commercial locations in a geographic environment, thus enabling characterization of what type of activity is normal or abnormal at a given location. Cloud systems may, for example, include but not be limited to Open Stack Hadoop and its various extensions, Amazon AWS, Google Cloud, etc., as well as various private and virtual private clouds, and also public clouds.

This approach enables users to ingest a very large stream of events of interest and then apply a number of different algorithms to learn from the raw data. For example, when attempting to determine social network groupings that are not explicit (that is, not links on Facebook, for example); this system helps when people want to associate without others knowing about it. It has obvious law enforcement and homeland security uses, but it also has commercial uses (for marketing). The system includes capabilities for identification of target-of-interest (TOI) homes, habits, favored routes, etc. It can help to identify the best route from one point to another, for example, by enabling a user to avoid routes where heavy social media usage is coupled to semantic indicators of threat (for example, when people are congregating in Simferopol for a “spontaneous” meeting, a user can avoid their location when transiting the city). Also, analyzing regular location updates (received from one of the many data sources) for a group of individuals can show common appearances (meetings, hidden links) and most-used paths.

Platform 110 collects data about tracked persons (TPs) with data derived from visualizing analytic software. The collected data enables agents to track multiple TPs in space and over time, so that agents can detect associations with other TPs. Platform 110 may collect data about the movement of TPs in and around certain locations. Thus the visualization tools enable agents to discover connections between members of different online social networks. All these abilities enable the system to infer causality of actions from an analysis of chronology of events. Platform 110 can also discern a frequent location of a TP and then is able to associate that location with a non-trackable person who is known to have real-world association with the TP. Also, platform 110 can parse the content of social media posts to obtain a picture of prevalent languages, sentiments, and events of interest. Platform 110 may then map the density of such prevalent items of interest on a small urban level to identify allegiances in certain areas. Platform 110 may deliver its data to a variety of computing devices in suitable formats, from dual-display office computers to mobile devices in the field in near real time. In some cases, the sentiment(s) extracted can cover a range of views on an issue, rather than just a simple keyword or hashtag match. That allows to paint a more accurate and detailed feature onto a visualization tool or use for further analysis. In some cases, for example, the system could use some semantic filtering and or a Natural Language Processing (NLP) processing system (or a similar suitable approach) to extract words and descriptions for available sentiments, in other cases an analyst user may create his own list of items to track for a particular type of sentiment he is interested in observing, or any combination thereof.

Potential social media sources may include, for example, but are not limited to TWITTER™, Tencent WEIBO™, INSTAGRAM™, SOSO™, FLIKR™, JIEPANG™, PANORAMIO™, VKONTAKTE™, YOUTUBE™, ODNOKLASSNIKI™, FOURSWUARE™, and WIKIMAPIA™. This list is exemplary only and by no means exhaustive. Different regions on earth may have culturally and linguistically selected “local” preferences for other social networks. It should be appreciated that any social media sources may be considered interchangeable according to the embodiment herein, even if they have varying features. It should be further appreciated that social media, social network and other subgroups may be treated and considered to be all variations of one and the same.

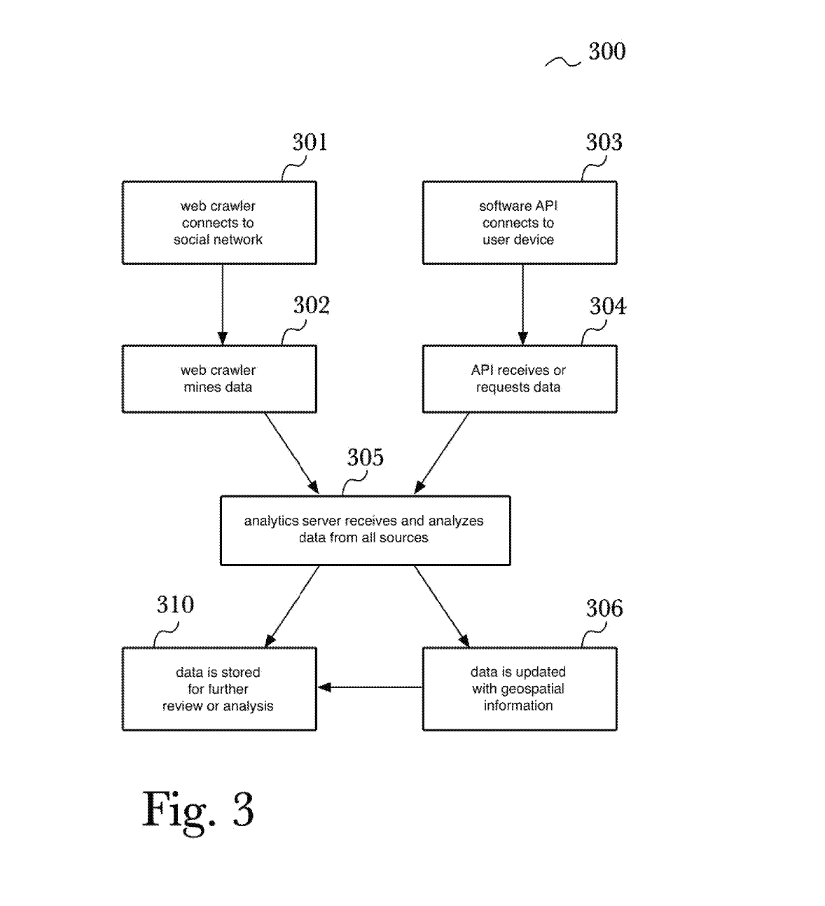

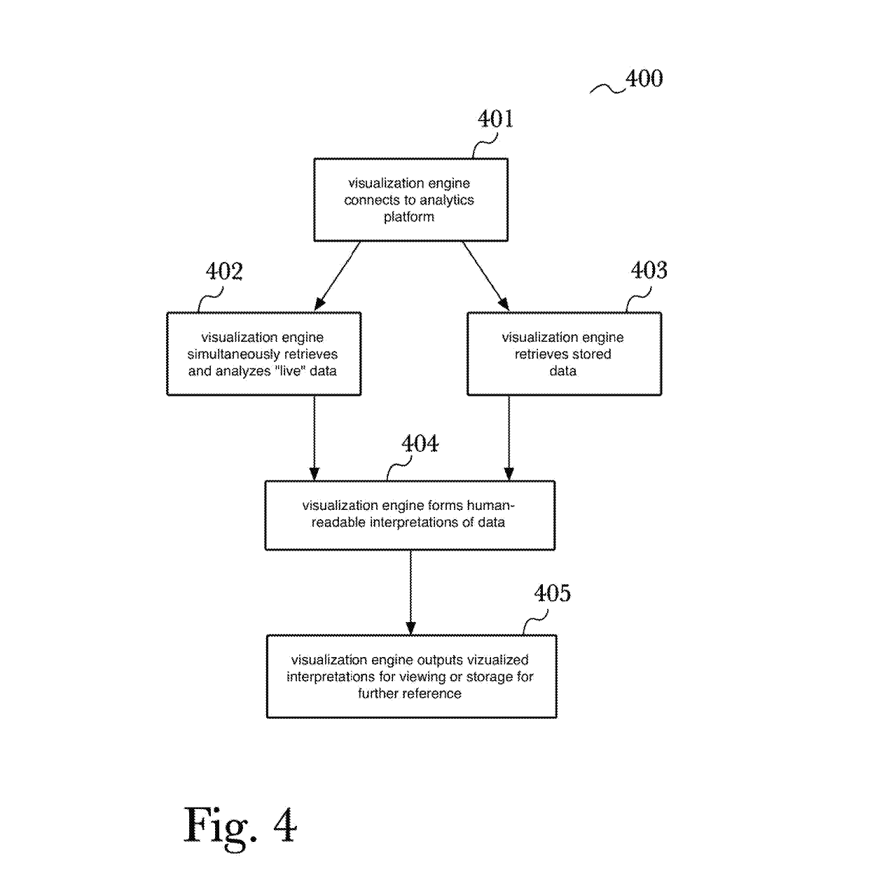

FIG. 3 is a method flow diagram illustrating an exemplary method 300 for analyzing and geolocating social interactions, according to a preferred embodiment of the invention. In an initial step 301, a web crawler may connect to a plurality of social networks, such as (for example) FACEBOOK™, TWITTER™, TUMBLR™, or any other such online social interaction network or service. In a next step 302, the web crawler may “crawl”, or proceed to read through and mine data from the social networks, such as user posting text, uploaded files such as images or audio/video clips, or attached or embedded metadata such as ID3 tags, EXIF metadata, or other metadata formats such as (for example) commonly used in the art to attach location metadata to a photo to indicate where it was taken. In a parallel step 303, a software API may connect to a user's device, such as through integration with a software app or through interaction via an integrated service such as a webpage or online product or service using the API. In a next parallel step 304, the API may receive (as in a passive context) or request (in an active context) information from the user device, such as hardware or software information available to the API through the integration (it should be appreciated that the scope and detail of information gained in this way may vary according to the specific nature of the device, as well as the nature of the API integration being utilized). In a next step 305, an analytics server may receive data from a web crawler or software API, and may then perform analysis on data received. For example, the analytics server might compare information received from multiple sources (such as, for example, images uploaded by a user to a social network as well as device information collected around the same time) and may form additional insights or associations from this data. In a storage step 310 the received data and any analysis results may be stored in a database for future reference (such as additional analysis later on, or review by a human analyst, or use in additional functions such as visualization as described below in FIG. 4). In a final analysis step 306, the analysis server may optionally update the received data with additional geolocation information, such as may be determined by metadata or device information received. For example, continuing the previous exemplary use case, the server might infer a user's location while they took the images, based on the reported location or network information from their device at the time the images were uploaded to the social network. In this manner, additional information that may not have been immediately available from either source when considered separately, becomes immediately clear through analysis of collected data.

FIG. 4 is a method flow diagram illustrating an exemplary method 400 for visualizing social interactions in a geospatial context. In an initial step 401, a visualization engine may connect to a social interaction analytics platform, such as that described previously (referring to FIGS. 1-3). In a next step 402, the visualization engine may receive data “live” from the analytics platform—that is, it may receive data in a streaming fashion as it is provided, such as a continuous supply of data as it is being received by the analytics platform. In a parallel step 403, the visualization engine may retrieve stored or historical data, such as from a database maintained by the analytics platform, for example including both collected social interaction data as well as the results of prior analyses performed by the platform. In a next step 404, the visualization engine may form visual interpretation based at least in part on the data received, such as to make a human-readable visual representation of collected data values and analysis inferences. In a final step 405, the visualization engine may output the visualized data representations for viewing (such as by a human user on a display) or storage (such as in a database for future reference, such as later viewing or modification).

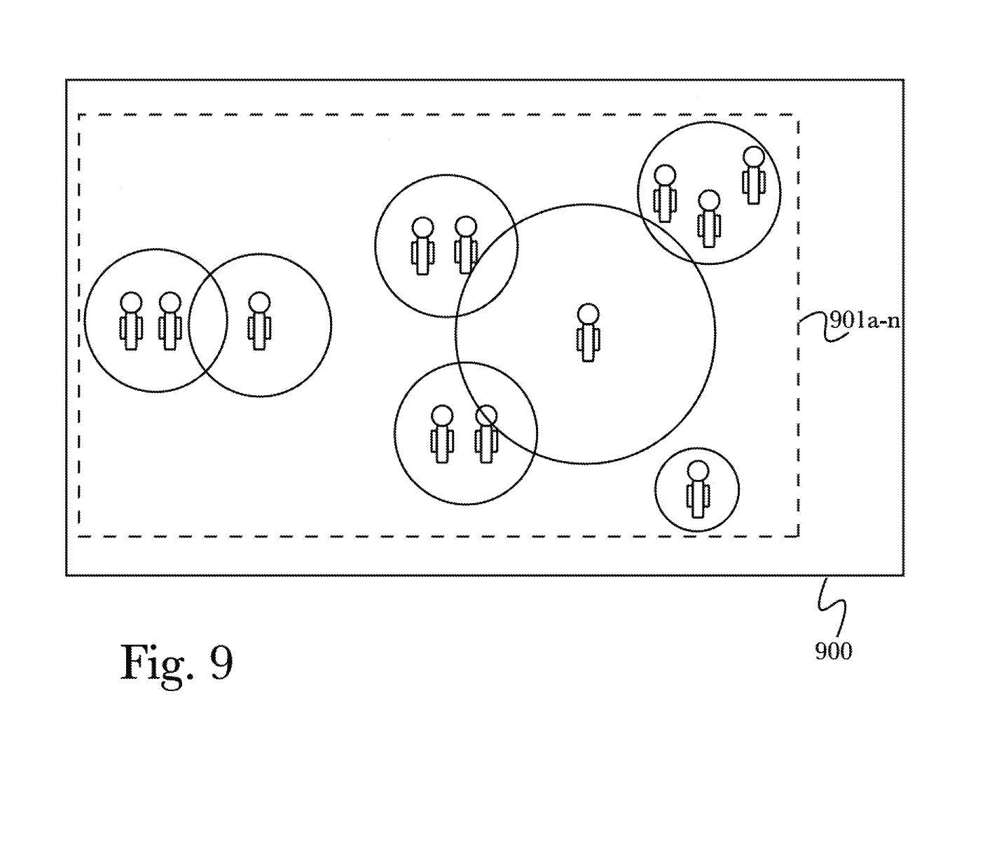

FIG. 5 shows a use case 500 of the residence finder approach shown below in FIG. 9, according to an exemplary embodiment of the system and method disclosed herein. Map 501 shows locations 502a-n where a person was tracked, showing how this person moves around during the day. In some cases, multiple intersections indicate the possibility that this person has additional business in certain locations, as indicated by arrow 503. When ported to a cloud architecture, this approach can process massive data sets on a daily basis for operation use. For example, the system may intermittently track the location of a high-importance individual. Over time, this tracking may result in the set of points, for example, beginning at point 502. By analyzing the geospatial and temporal pattern of the collected tracking locations, this individual's residence can be estimated.

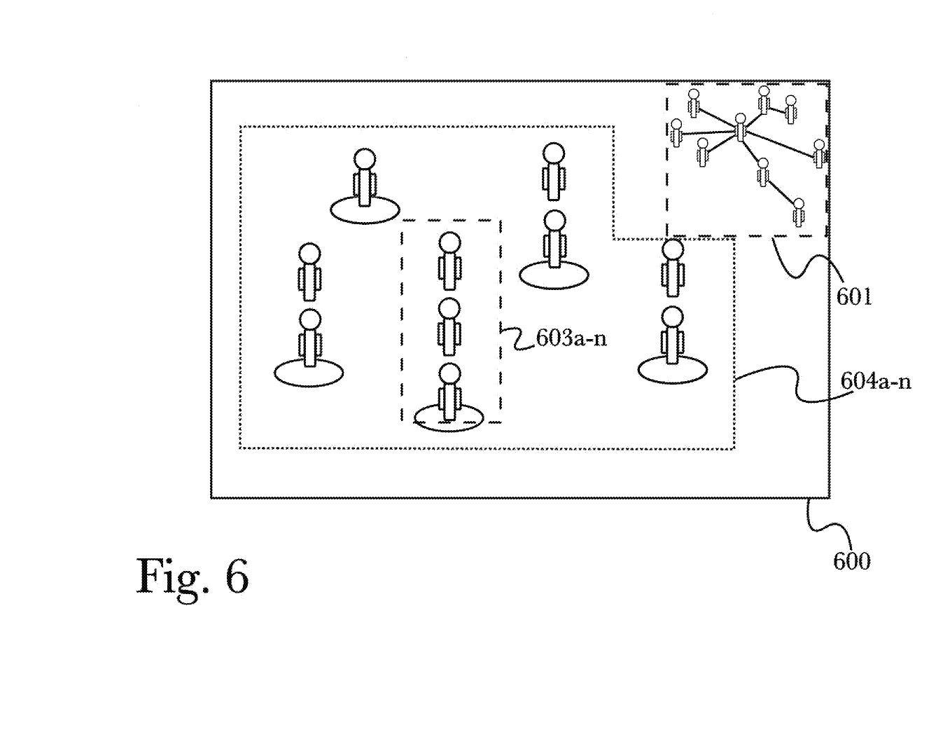

FIG. 6 shows an exemplary screen 600 of a visualizing analytic software tool for finding locations of common interest to a group, according to an exemplary embodiment of the system and method disclosed herein. Members of networks are visualized in a stacked arrangement. By looking at network 601 of people who are connected, some directly and some indirectly, and looking at where they have common locations, as indicated by members 603a-n arranged into visual stacks 604a-n by location, it can be observed which members of network 601 are associating. By looking at each location 604a-n as shown on map 602, the system can detect locations where these people often congregate. The same people may congregate in different locations, or different subsets of network 601 may congregate in different locations, either at the same time or at different times. These behavior patterns are further analyzed and described below.

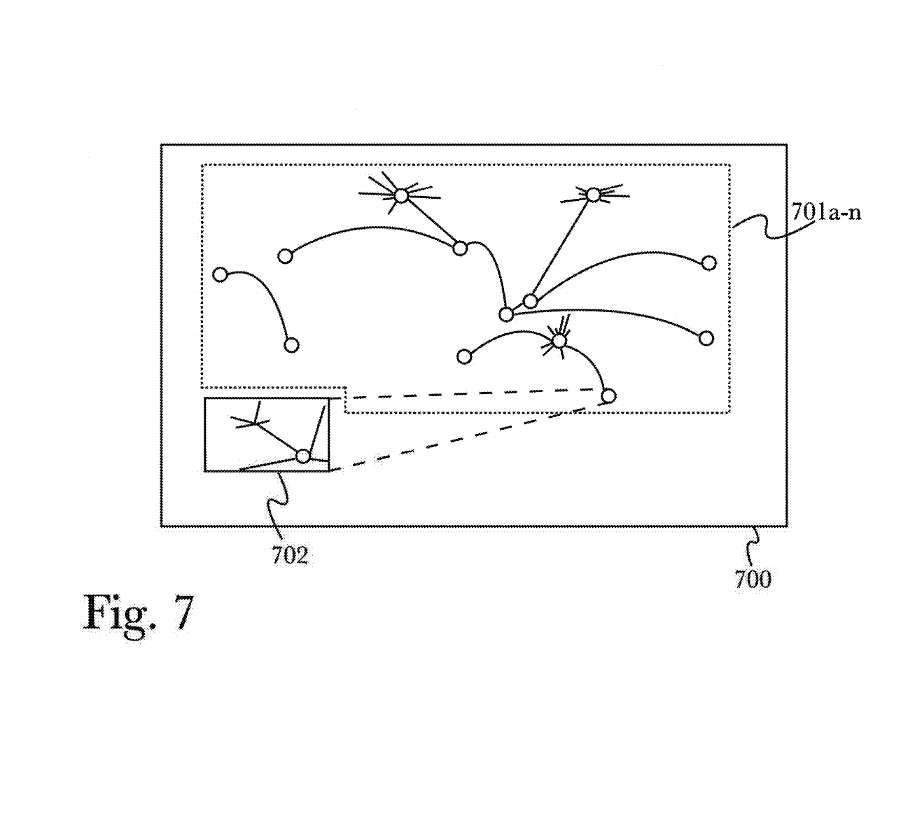

FIG. 7 shows an exemplary screen 700 of a visualizing analytic software tool, according to an exemplary embodiment of the system and method disclosed herein. On an exemplary global map 700 multiple subgroups 701a-n of an exemplary social network may be shown in their proper geolocations throughout the world. By clicking or otherwise interaction with a subgroup 701, a user may view a sub-map 702 showing local details with more local definition, such as “who is where”, and other visualized data. This visualization enables a user to understand where members of groups are from and where they may be moving to. According to some arrangements, different zoom levels may be shown for both the global map 700 and the window(s) 702. In some arrangements, multiple zoom levels may be visible concurrently (for example, by clicking on a cluster inside 702), and these may be shown as inset windows, separate windows or even on separate screens.

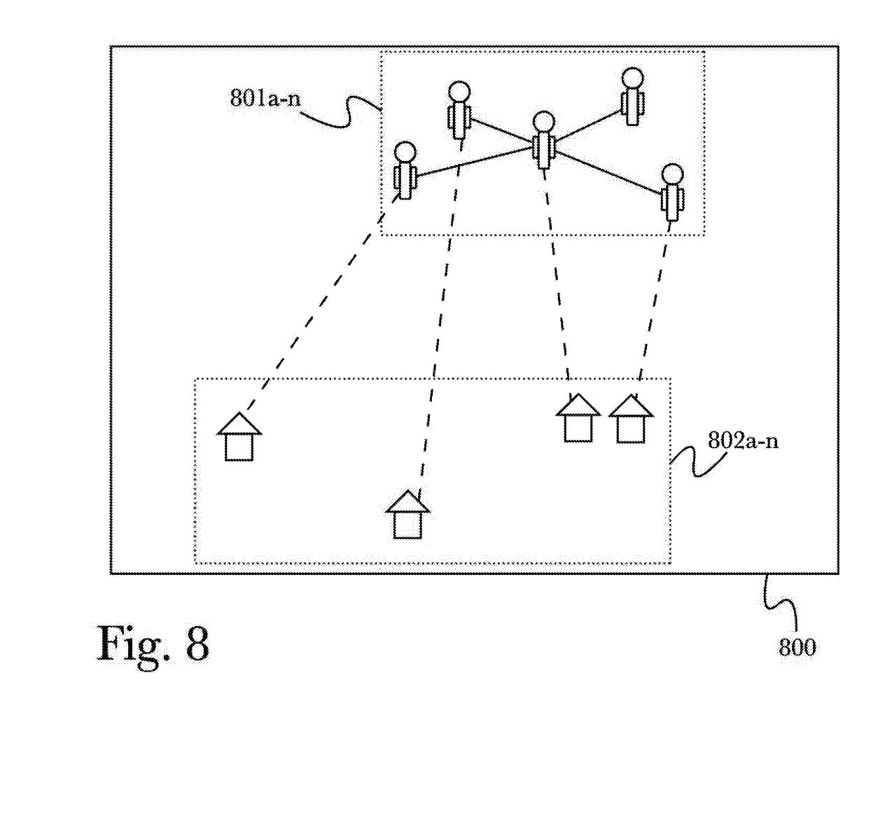

FIG. 8 shows an exemplary screen of a visualizing analytic software tool, identifying residences of individuals or groups on map 800, according to an exemplary embodiment of the system and method disclosed herein. For each member of the network 801a-n a corresponding location 802a-n may be shown indicating where the member stays for many hours, such as, for example, an entire night, thus indicating a likely location of their home.

FIG. 9 shows an exemplary screen of a visualizing analytic software tool that relates entities to event series through space and time, according to an exemplary embodiment of the system and method disclosed herein. According to the embodiment, where people move around during the day, which places they visit, and how long they stay may be viewed in addition to simple location information. Map 900 would be typically the background for such a display, and visualizations of the locations of tracked persons (TPs) may be viewed 901a-n, for example, using color coding or other visual indicia, that may correspond to tracked data such as the time they the spend or when they are at these respective locations. Additionally, relationship between TPs may be seen through overlaps in data, such as individuals that frequent the same locations or who always stay in a location for the same length and at the same time, or other such correlations.

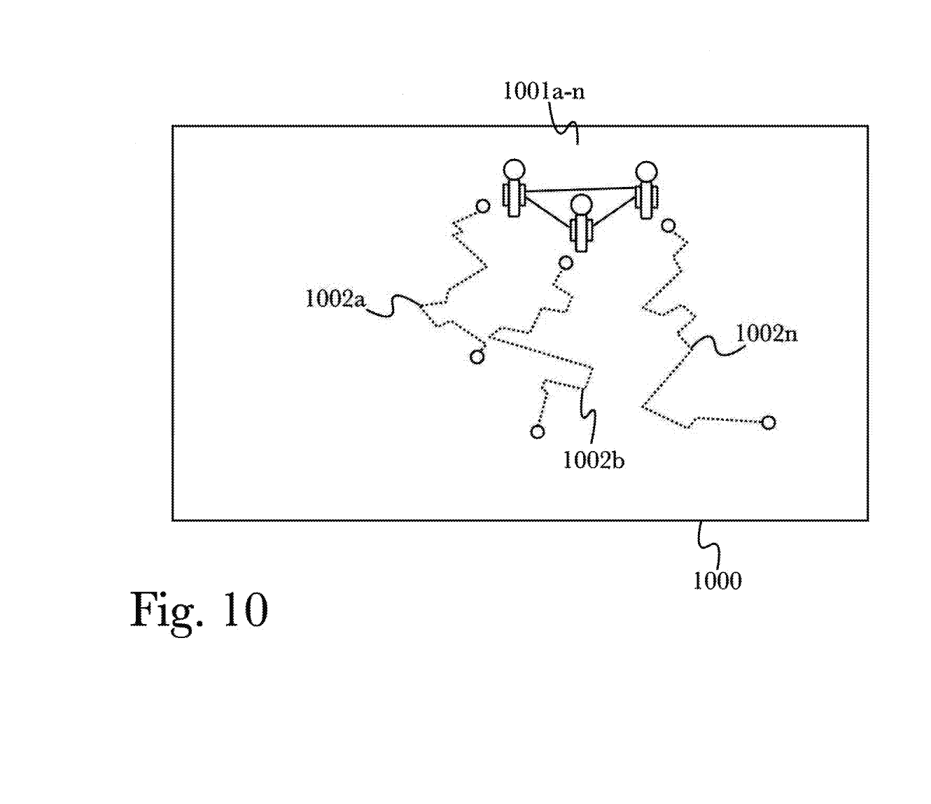

FIG. 10 shows an exemplary screen of a visualizing analytic software tool that displays the travel patterns of every one in a data set, according to an exemplary embodiment of the system and method disclosed herein. This trip analyzer platform enables a user to track members 1001a-n of a social network on map 1000. In the illustrated example, three members visualized take separate trips 1002a-n, and they don't happen to interact or even pass by the same places. In some cases, for example, these people may be traveling to a social event, but they may stop someplace, such as a bar or restaurant, to meet together, and they may then go together to a further destination. These travel patterns may be used as an indication of more closeness within a subgroup of a larger social network.

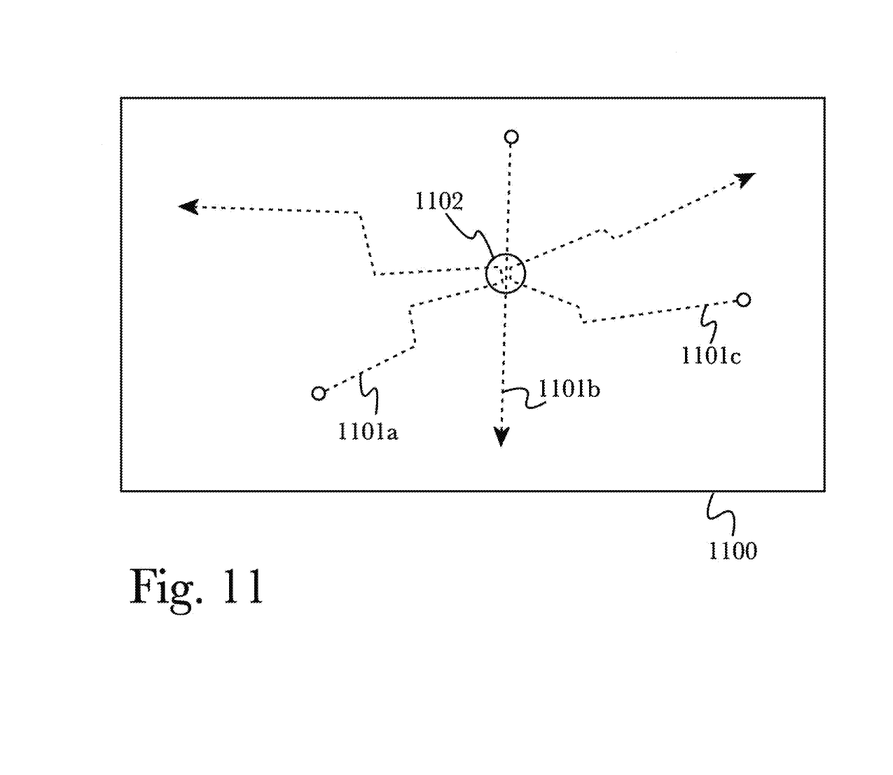

FIG. 11 shows an exemplary screen of a visualizing analytic software tool for discovering hidden relationships between individuals, according to an exemplary embodiment of the system and method disclosed herein. The system looks for exact locations where tracks of such group members may intersect, either at the exact same location or closely nearby. Map 1100 shows traces of people 1101a-n, and indicates where traces intersect at location 1102. Traces may not show an exact intersection for various reasons, for example if the people go into a building from different entrances, and the tracking means, such as GPS, etc. may not be accurate enough to show their exact locations within the building even though the people may be at the same location.

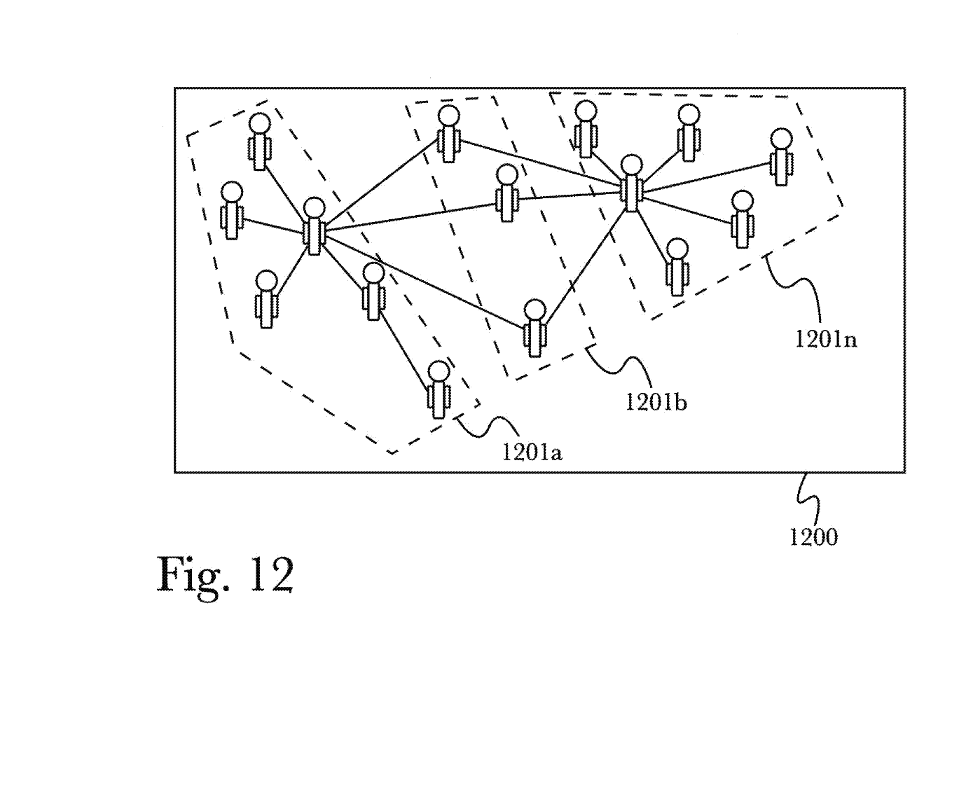

FIG. 12 shows an exemplary screen of a twin finder visualizing analytic software tool, according to an exemplary embodiment of the system and method disclosed herein. A twin finder may be used to find relationships within a given network structure. Such network members are known as network “twins,” that is, people who belong to two separate but identical (or very similar) networks. Network members 1201b may be members of both networks 1201a and 1201n. Thus members 1201b may be considered “twins” because they are participating in both networks.

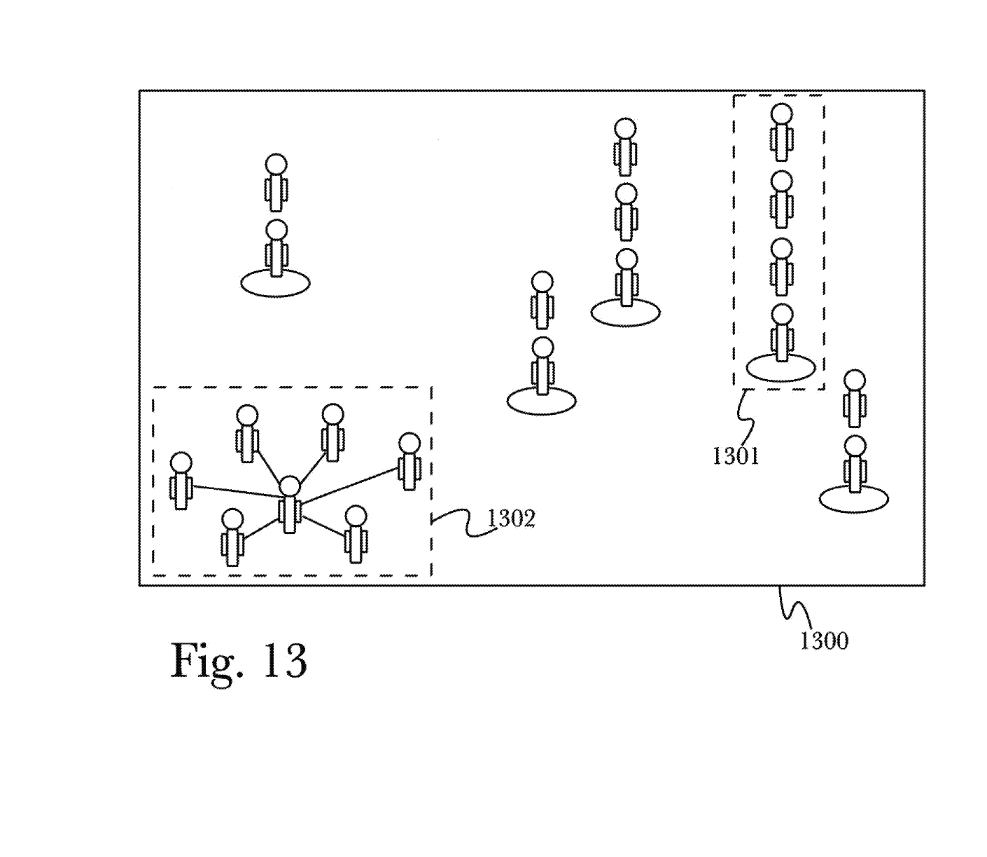

FIG. 13 shows an exemplary screen 1300 of an enclave view on a global map, according to an exemplary embodiment of the system and method disclosed herein, enabling identification of countries that a network may affect. Stacked network members may be shown in an exemplary global distribution, showing how network members may meet on a global basis rather than just a local basis, by positioning visual stacks of members in countries or regions of a large-scale or global map view, rather than at specific points on a local map. A location of concentrated members may be indicated with a stacked visual element 1301 and can be expanded into a networking view as shown by cluster 1302, for example when hovering or clicking with a computer mouse or other input device (for example, a touchscreen or stylus), etc.

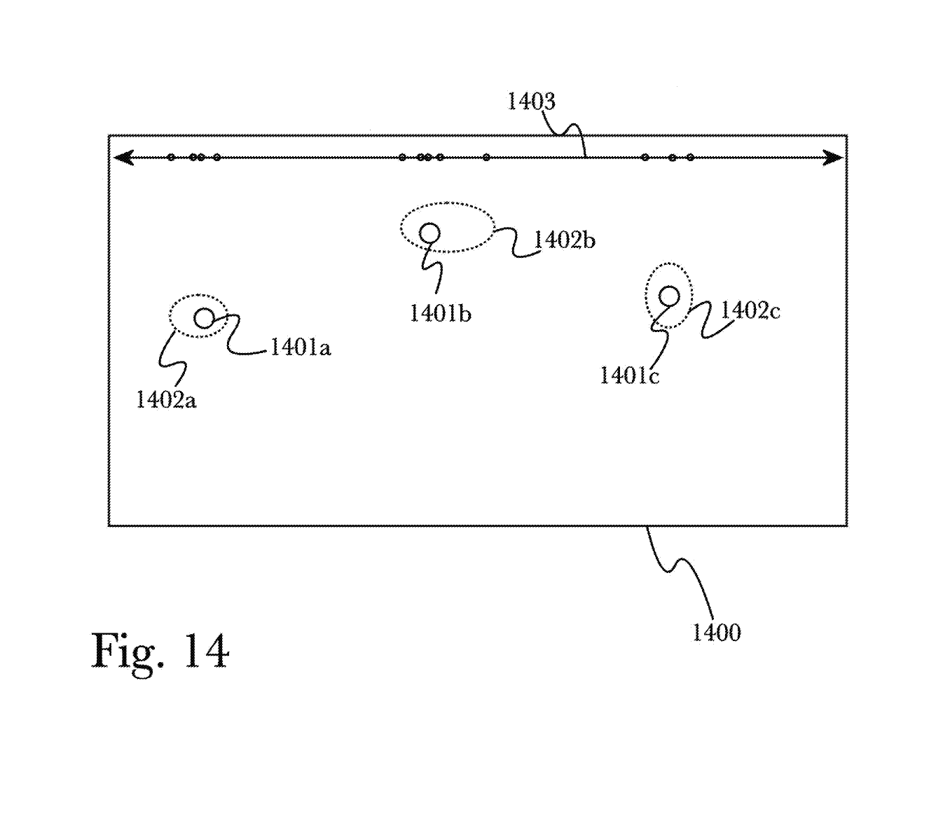

FIG. 14 shows an exemplary screen of real-time geospatial movement of certain people, according to an exemplary embodiment of the system and method disclosed herein, enabling location of entities who may be actively trying to avoid tracking or conceal their location. Exemplary current locations are indicated by location markers 1401a-n. An event time scale 1403 may be used to show the time lapse between locations, for example with the far edge indicating the present or real-time. Amorphous graphs 1402a-n around the location markers, similar in concept to an “electron cloud”, may be used to indicate movements of the TP within the space on map 1401.

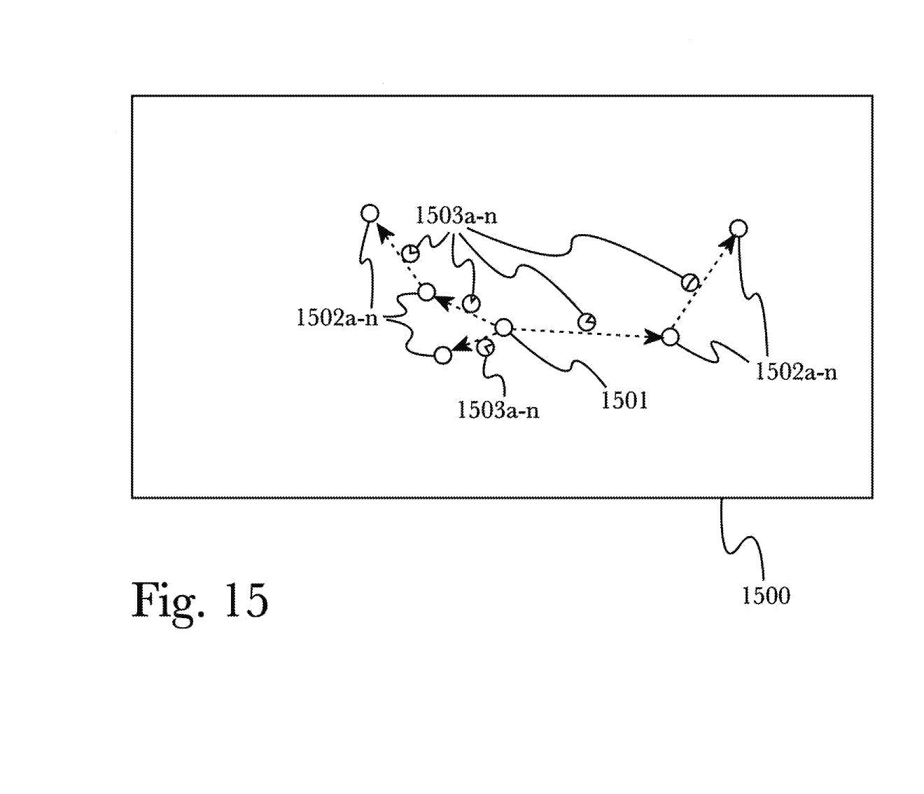

FIG. 15 shows an exemplary screen 1500 of a trigger finder that may be used to track cause and effect through time and space, according to an exemplary embodiment of the system and method disclosed herein. For example, certain people may meet in a certain place, and then this group may travel to meet with other people at various other places. Knowing the sequence of these meetings enables users to form conclusions about how information may be spread via personal, rather than electronic, means. An initial event 1501 may be displayed in the middle and then leads to secondary events 1502a-n spread out throughout the geography. Arrows may indicate the path or direction people take, with time indicators 1503a-n showing where each person along his track was at the time it was observed.

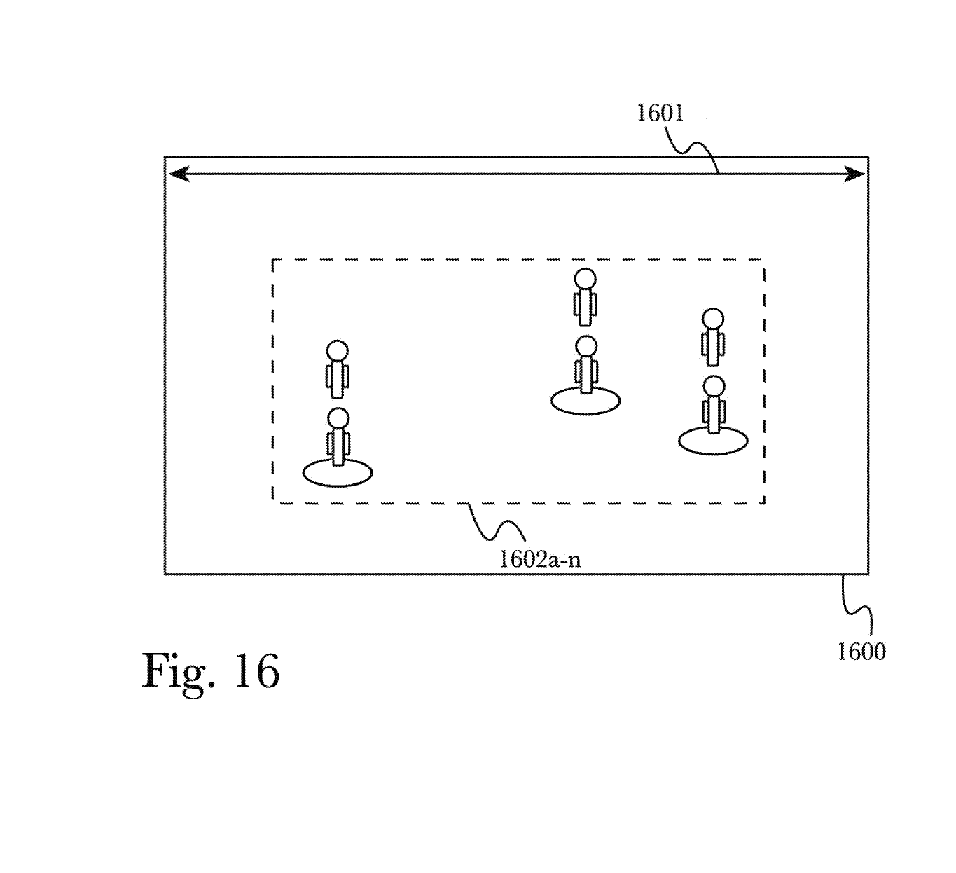

FIG. 16 shows an exemplary screen 1600 of an approach to finding social centers, according to an exemplary embodiment of the system and method disclosed herein. A social center may be any gathering place or locus of social interaction, for example including stores, restaurants, parks, parking lots, street intersections, or any other location where people may meet, generally within a small district of a city or even within a single building (such as a particular floor, department, or room). A user may view which groups of people 1602a-n have participated in social activities, and may correlate this with a shown timescale 1601 to identify at what times or during what timeframes interactions took place. This may be used to follow people from one event to another, as well as to enable users to understand who the leaders of these groups are, for marketing purposes, for example, because these leaders could then disseminate information to all the members of the group. These events could be meetings, sitting down at coffee shops, etc.

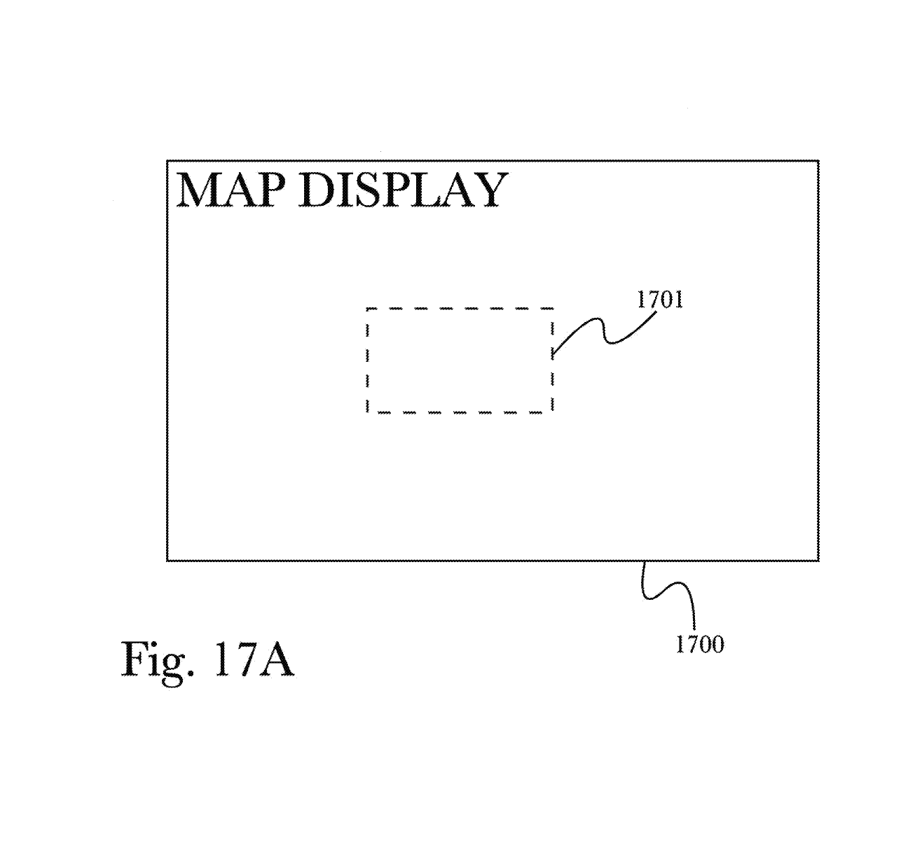

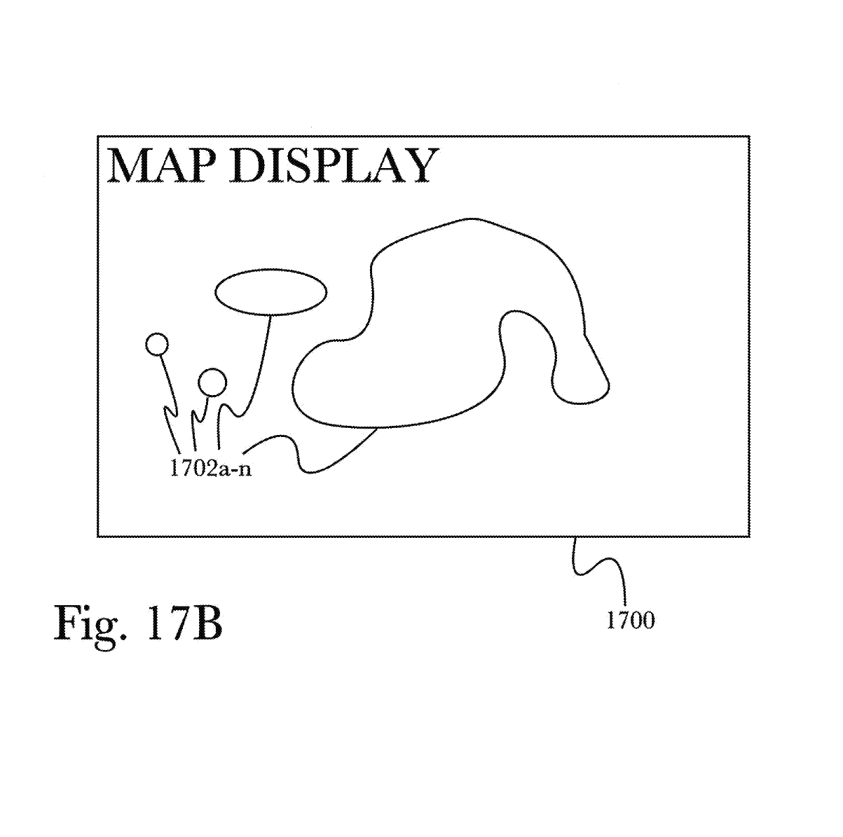

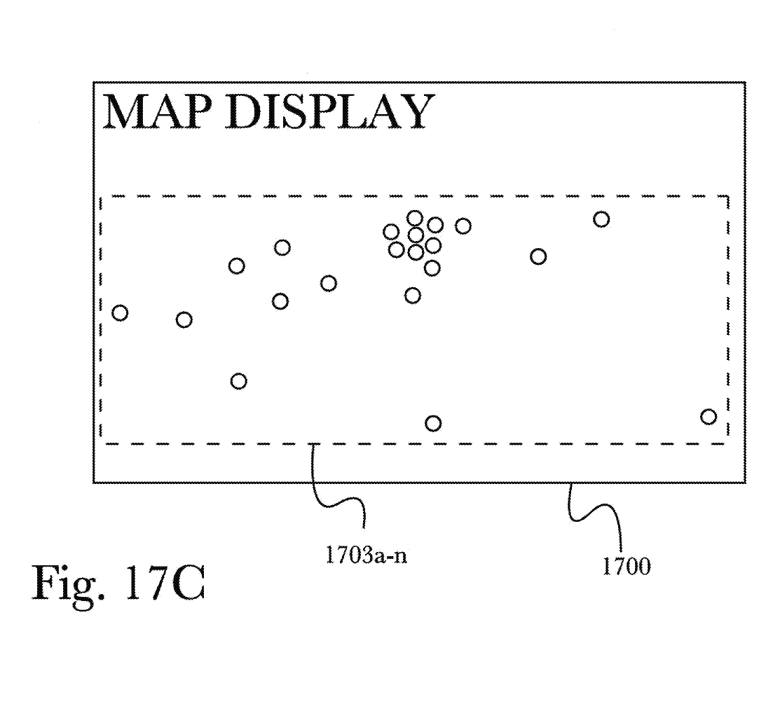

FIGS. 17A-17C show available query and visualization functions of a visualizing analytic software tool, for various types of content of social media, according to aspects of the system and method disclosed herein. The tool enables a user to make a spatial query based on one or more search terms, or just a search term, and these aspects also enable a user to do time mapping to see how people move, or where they commonly move around or settle in one place. It also enables users to do things like check in at a place (for example, as users can check in on apps such as FOURSQUARE™ or other types of social media), and it supports WIKIMAPIA™ and TWITTER™ stream processing.

FIG. 17A shows an exemplary screen according to an exemplary embodiment of the system and method disclosed herein. On a displayed map 1700, an area of interest may be enclosed by a line or bounding box (or other bounding region shape, such as triangles, ellipses, or irregular or “freehand” shapes) 1701 (optionally with additional visual indicia for clarity, such as color or dashed-line styling), from which a detectable prevalence or pattern of search queries or keywords was detected. A search could be, for example, based on religious or cultural backgrounds or other interests or activities. The display may show a spatially correlated area of interest. For example, colored dots may be used to indicate one kind of media while dots of another color (or other visually-distinct style, such as flashing or pulsating) could be another kind of media.

FIG. 17B shows an exemplary screen according to an exemplary embodiment of the system and method disclosed herein. Density points may be displayed as dots, shapes, or a heat map 1702a-n, appearing on a map 1700, and may be determinate-normalized for total people. In this manner, the points may be used to show where people are and how active they are, or to show how individuals move around while being active. Intensity and or periods can be shown as false color “clouds” (analogous to electron clouds) or in a style similar to that employed on rain radar maps, where each color represents a range of activity or time spent, or dwelled, etc.

FIG. 17C shows an exemplary screen according to an exemplary embodiment of the system and method disclosed herein. On a map 1700, environmental and user-diversified calculations may be applied to discover particular activities 1703a-n, or particular sequences in interactions on social media (for example), or in specific types of groups. This functionality enables users of the visualization system to understand (for example) who are trend-setters in a group, and other social insights.

Additional visualizations may be added as needed to enhance the system. All these visualizations may be also made available for viewing on mobile communication devices as well as on the display units of computing devices used by analysts, office workers, field agents, and other employees.

In some cases, the system may collect data about tracked persons (TPs), with the data derived from a visualizing analytic software tool running on a computer. In such cases, the collected data may enable agents to track multiple TPs in space and over time, so that associations with other TPs may be detected. The same system, may in certain cases, collect data about the movement of TPs in and around certain locations. Further, these visualization tools may enable agents to discover connections between members of different online social networks. All these abilities enable the system to infer causality of actions from an analysis of chronology of events. Additionally, a subset of the collected data may be delivered in a suitable format to mobile devices in the field in near real time. In other cases, the system may discern a frequent location of a TP and therefore be able to associate that location with a non-trackable person who is known to have real-world association with the TP. Also, the system may parse the content of available posts of social media for purposes of obtaining a picture of prevalent languages, sentiments and events of interest. The system may then in some cases map the density of such prevalent items of interest on a small urban level to identify allegiances in certain areas.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

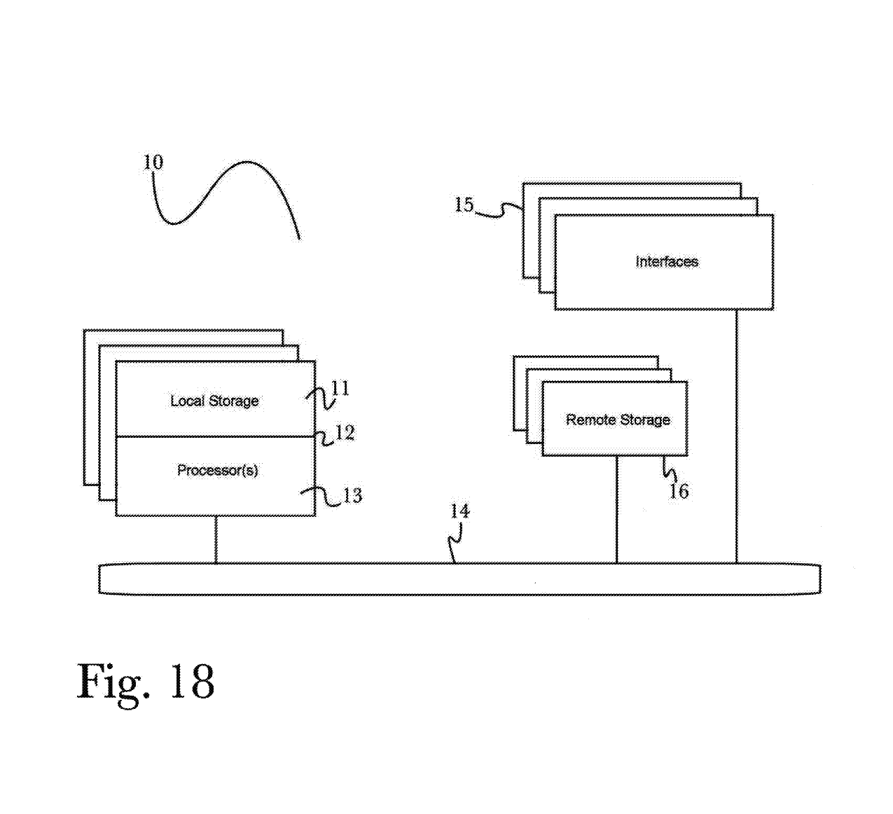

Referring now to FIG. 18, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 18 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

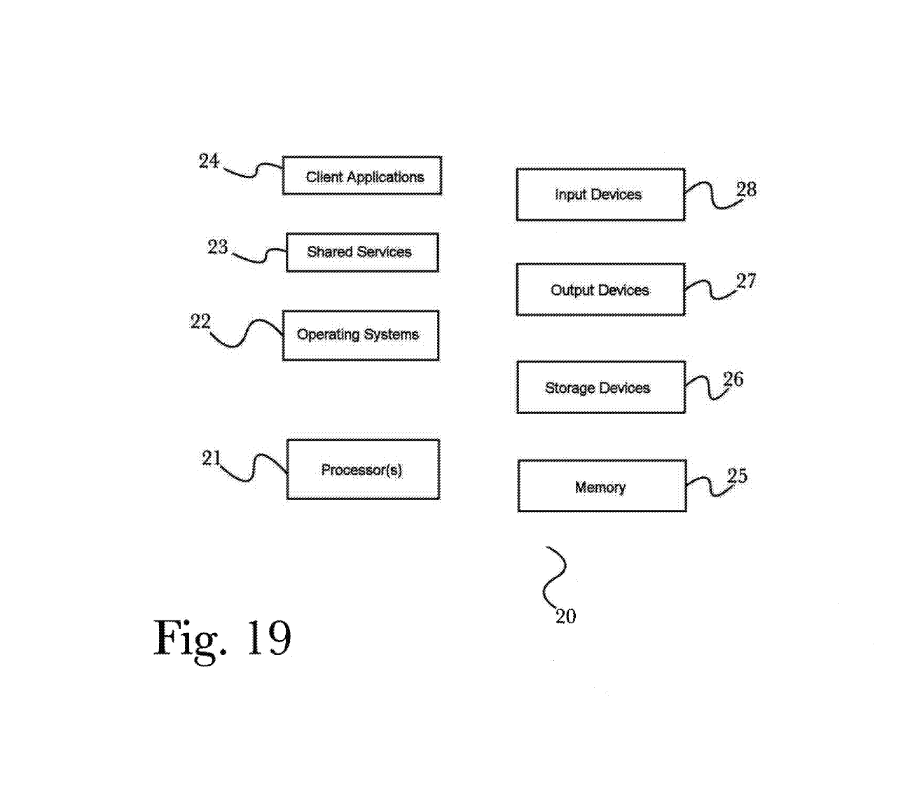

In some embodiments, systems according to the present invention may be implemented on a standalone computing system. Referring now to FIG. 19, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 18). Examples of storage devices 26 include flash memory, magnetic hard drive, CD-ROM, and/or the like.

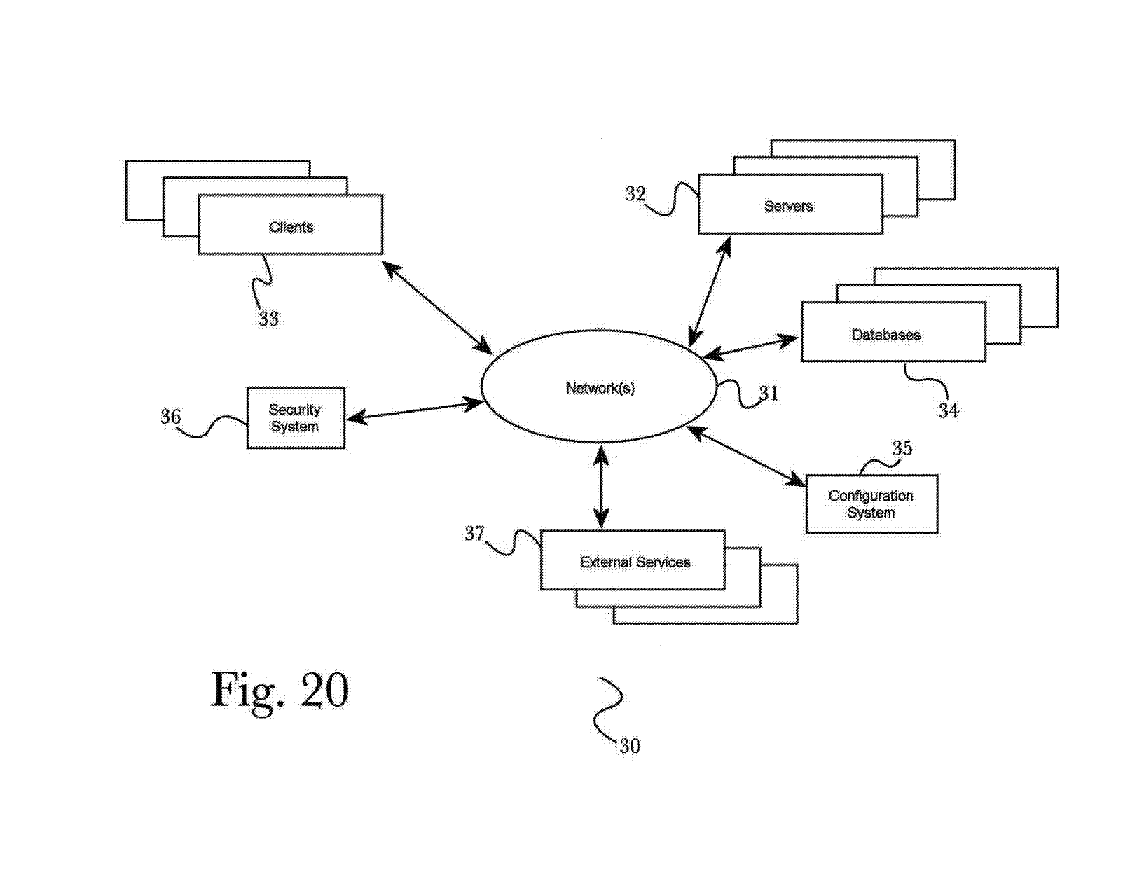

In some embodiments, systems of the present invention may be implemented on a distributed computing network, such as one having any number of clients and/or servers. Referring now to FIG. 20, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 19. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

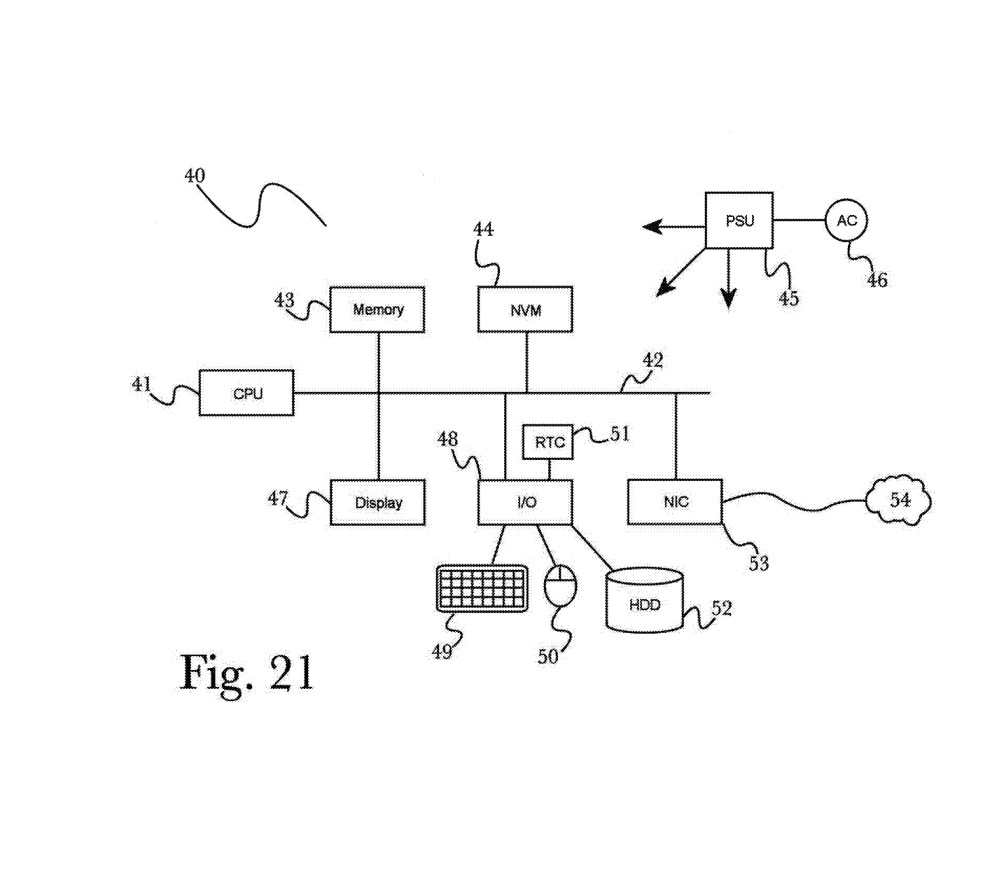

FIG. 21 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for analyzing and viewing social interactions based on user devices, comprising:
a geolocation and analytics server comprising at least a plurality of software programming instructions stored in a memory of and operating on a processor of a computing device, configured to receive information from a plurality of social media networks, the information comprising at least social interaction information pertaining to users of the social media network and a plurality of geolocation information; and
a visualization engine comprising at least a plurality of software programming instructions stored in a memory of and operating on a processor of a computing device, configured to produce a plurality of visual representations of analyzed social interaction information received from the geolocation and analytics server;
wherein the geolocation and analytics server analyzes received social interaction information;
wherein the geolocation and analytics server derives new information based at least in part on the results of the analysis;
wherein the geolocation and analytics server provides at least a portion of the received and derived social interaction information to the visualization engine;
wherein the visualization engine produces a plurality of visual representations based at least in part on the received information; and
wherein the visualization engine presents at least a portion of the visual representations to a human user for review.

2. The system of claim 1, wherein the geolocation information comprises metadata associated with a social media post.

3. The system of claim 1, wherein the connected resources comprise at least a plurality of user devices.

4. The system of claim 3, wherein the analytics and geolocation platform further comprises a software API; wherein the API is integrated into software operating on a user device and configured to facilitate two-way communication between the user device and the geolocation and analytics server.

5. The system of claim 4, wherein the geolocation information comprises at least location sensor information from a user device.

6. The system of claim 1, wherein the connected resources comprise at least a plurality of social media networks.

7. The system of claim 6, wherein the analytics and geolocation platform further comprises a software web crawler configured to retrieve information from the plurality of social media networks.

8. A method for analyzing and viewing social interactions based on user devices, comprising the steps of:
receiving, at a geolocation and analytics server comprising at least a plurality of software programming instructions stored in a memory of and operating on a processor of a computing device, configured to receive information from a plurality of social media networks, the information comprising at least social interaction information pertaining to users of the social media network and a plurality of geolocation information, social interaction information;
analyzing the information;
updating the information with location-based information based at least in part on the analysis results; and
storing at least a portion of the information for future reference.

9. The method of claim 8, further comprising the steps of:
receiving, at a visualization engine comprising at least a plurality of software programming instructions stored in a memory of and operating on a processor of a computing device, configured to produce a plurality of visual representations of analyzed social interaction information received from the geolocation and analytics server, at least the social interaction information;
generating a visual representation based at least in part on the information received; and
providing the visual representation to a human user for review.

10. The method of claim 9, further comprising the step of storing the visual representation for future reference.
